(19) United States
(12) Patent Application Publication
(10) Pub. No.: US 2015/0127578 A1
(43) Pub. Date: May 7, 2015

(54) STATELESS SIMULATION SERVICE

(71) Applicant: Amazon Technologies, Inc., Reno, NV (US)

(72) Inventors: Raghunathan Kothandaraman, Bangalore (IN); Andygibb Halim, Seattle, WA (US); Mukunda Nallur Srinivasagowda, Bangalore (IN); Mark Aran Aiken, Seattle, WA (US)

(73) Assignee: Amazon Technologies, Inc., Reno, NV (US)

(21) Appl. No.: 14/133,088

(22) Filed: Dec. 18, 2013

(30) Foreign Application Priority Data
Nov. 1, 2013 (IN) 3256/DEL/2013

(51) Int. Cl. G06Q 10/06

(52) U.S. Cl. CPC G06Q 10/067
USPC 705/348

(57) ABSTRACT

A proxy simulation service can be used to test a complex system, such as a fulfillment network, that depends on upstream and downstream processes in order to operate. The proxy simulation service can be configured to send an event, such as an order request, so as to appear to be sent from a process upstream of the system; and can be configured to receive a request from the system, such as a request to charge payment information, so as to appear as a downstream process of the system. The proxy simulation service can then simulate a response to the received system request based on the request and on state information related to the request. The simulated response can then be sent to the system being tested.

### CROSS-REFERENCE TO RELATED APPLICATIONS

This application is based upon and claims the benefit of priority from Indian Patent Application No. 3256/DEL/2013, filed on Nov. 1, 2013, the entire contents of which are incorporated herein by reference.

### BACKGROUND

Complex systems frequently depend on multiple upstream and downstream processes. For example, an order fulfillment network (which may be a chain of both computing and non-computing processes that work together to fulfill a customer order) is a complex system that makes business-critical decisions based on information received from a sequence of upstream and downstream processes. An upstream process can include any process that can send an event (including a request) to the system, whereas a downstream process can include any process to which the system can send an event (including a request).

In particular, an example of an upstream process in an order fulfillment network includes a customer placing an order and providing payment information. The order fulfillment network may receive the order and submit a request to a downstream process, such as a payment gateway, to verify the customer's payment information and process a charge. In response to this request, the payment gateway may provide any of several responses. For example, the payment gateway may successfully verify the customer's payment information and process a charge. Alternatively, the payment gateway may not be able to process the customer's payment information and decline a charge. In each of these cases, the payment gateway may provide a response to the order fulfillment network indicating either a successful charge or a failure. In addition, it may be the case that no response is received from the payment gateway in a certain period of time, and the request times out. Furthermore, the order fulfillment network may include any additional number of upstream and downstream processes.

Complex systems, such as an order fulfillment network, are expected to be robust enough to handle jumbled messages (e.g., out of order events) and dropped events, in addition to normal events. Business-critical processes, such as processing of a customer's payment information, may not proceed as intended if the business-critical processes are not robust. As one example, for the order fulfillment network described above, it is important that the order fulfillment network respond correctly depending on the response received from the payment gateway. If the payment gateway indicates that the customer's payment information was successfully charged, the order fulfillment network may proceed to the next step of fulfilling the customer's order. If the payment gateway indicates that the customer's payment information was declined, the order fulfillment network may need to request alternate payment information from the customer. In addition, if no response is received from the payment gateway after a certain period of time, the payment gateway may want to send a second payment request to the payment gateway.

Despite the importance of systems that depend on upstream and downstream processes, testing such systems is complex. Manually recreating all or even most possible scenarios that can occur in such a system is seldom feasible and tedious at best. For example, to test a series of steps or processes, it is frequently necessary to test a series of sub-steps, each of which may provide any of multiple responses, and which may depend on additional sub-steps. In addition, attempting to keep track of which step, or sub-step, or sub-sub-step, is being tested could quickly overwhelm the memory resources of any test system, particularly for any appreciable number of test cases.

### BRIEF DESCRIPTION OF DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure.

FIG. 1 is a block diagram of an order fulfillment network that may be tested utilizing a proxy simulation service according to an embodiment.

FIG. 2 is a block diagram of illustrative data flows and operations of a proxy simulation service, according to an embodiment, in communication with a system that depends on upstream and downstream processes.

FIG. 3 is a block diagram of illustrative data flows and operations of a proxy simulation service, according to another embodiment, in communication with a system that depends on upstream and downstream processes.

FIG. 4 is a flow diagram of an illustrative process for simulating a charge request utilizing a proxy simulation service according to an embodiment.

FIG. 5 is a table illustrating example responses to a system under test of a proxy simulation service, based on received request and state information according to an embodiment.

FIG. 6 is a flow diagram of an illustrative process of a proxy simulation service according to an embodiment.

FIG. 7 is a block diagram depicting an illustrative embodiment of a computer system configured to function as a proxy simulation service according to an embodiment.

### DETAILED DESCRIPTION

### Introduction

Aspects of the present disclosure are directed to testing a system, such as a fulfillment network, that can be configured to send information to, and receive information from, at least one upstream or previous process and at least one downstream or subsequent process. The system under test may include one or more computer systems running various processes and services. In some embodiments, the system under test also may include, or receive information from/send information to, other processes and services that are not executed by a computer. In some embodiments, a computing device running a proxy simulation service can be configured to send an event of a sequence of events to the system for testing purposes. For example, the computing device can send an event, such as an order request, so as to appear to be sent from a process upstream of the computing system. The computing device can receive from the system a request, such as a request to charge payment information that is based on the sent event. The system request may be any request to process information, perform an action, return a result, and/or any other form of request. In receiving the system request, the computing device may function as a process downstream of the computing system. The computing device running the proxy simulation service may receive state information associated with the system request from a source external to the computing device. For example, the state information may indicate how many times the system has sent the system request. In other words, for the charge verification example, if the system is sending a charge verification request for the second time, the computing device may receive state information indicating that the received charge verification request is the second such request. Receiving the state information allows the computing device running the proxy simulation service to remain stateless itself. For example, the computing device may receive the state information from an external source, so it is not necessary that the computing device keep track of state in a memory.

“Proxy simulation service” and “stateless simulation service” may be used herein interchangeably and should be understood to refer to the same simulation service. The computing device implementing the proxy simulation service may determine a simulated response to the system request based on the system request and the state information. For example, if the computing device knows that a received request is a charge verification request, and it knows how many times the system has sent such a request, the computing device may determine, according to a test case being simulated, whether to provide a response indicating a successful charge, a failed charge, or provide no response at all. The computing device may provide the simulated response to the system. The computing device may validate a state of the computing system after receiving the simulated response.

The state information may be received from the system under test or from a third party. If the state information is not provided with the system request, the computing device implementing the proxy simulation service can send, after receiving the system request, a second request to receive the state information associated with the system request. In some embodiments, the computing device may store the simulated response in a memory. In addition, the computing device can provide to the system data associated with the sent event and data associated with the simulated response. For example, the provided data can be stored with the sent event and the simulated response as a single test case.

In some embodiments, the computing device implementing the proxy simulation service may simulate an upstream or a downstream process, and each upstream or downstream process may be associated with a node. The computing device may receive context information indicative of a node of an upstream or downstream process, and interpret the received system request based on the context information. Also, the proxy simulation service is configured to be scalable. For example, the computing device implementing the proxy simulation service can be configured to send at least five hundred events per minute.

In some embodiments, the proxy simulation service functions both as a test bed that can push a sequence of events to a system and also as a single entity that simulates downstream processes upon which the system is dependent. As such, the simulation service is self-contained, and no other processes need to be simulated for testing. In yet other embodiments, the proxy simulation service can wrap the sequence of events to be pushed and the simulated responses from downstream processes in a single test case. In addition, the system can be progressively tested by adding more of these test cases to the proxy simulation service.

In some embodiments, the proxy simulation service uses the system under test to record state. By using the system under test to record its state, the proxy simulation service may remain stateless. For example, the computing device implementing the proxy simulation service can receive state information based on a sequence of events associated with a system request. The computing device implementing the proxy simulation service can provide a simulated response to the received system request based on the received system request and the received state information. The simulation service can be scaled by, for example, adding more computing devices or hosts.

In another embodiment, a command pattern may be used extensively by the proxy simulation service and/or the system under test. For example, each request from the system under test may be implemented as a command, and the proxy simulation service may provide each response as a command as well. A request command from the system may result in the proxy simulation service sending in a sequence of response commands. By utilizing a set of request and response commands, complex test cases can be written which are permutations of these commands, allowing for easy and extensible defining of test cases.

In some embodiments, a command interpreter allows a given request command to be interpreted by gathering context information. In addition, a protocol reader may be used to determine a list of response commands that a proxy simulation service should send. Each response command can be an event that is pushed to the system under test or a simulated response for a downstream process. In addition, the proxy simulation service may interpret commands differently for different test cases by altering the context gatherer, the protocol reader, or both.

### Fulfillment Network Environment

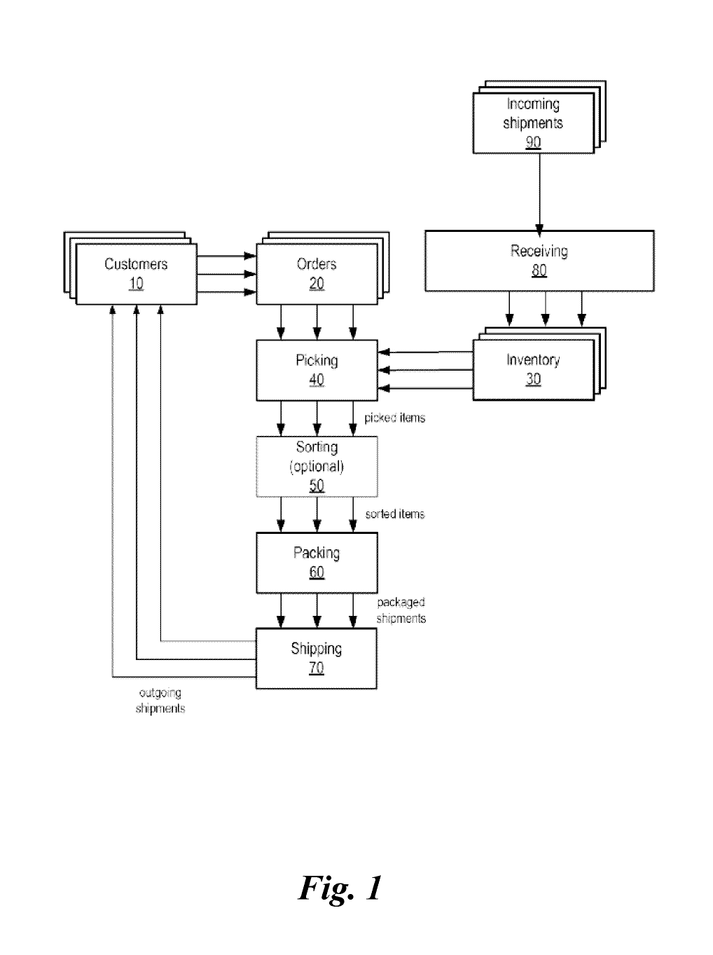

An order fulfillment network is an example of a complex system that depends on multiple upstream and downstream processes. FIG. 1 illustrates an example of a fulfillment network. The fulfillment network may include computing processes, such as processing orders 20, as well as non-computing processes, such as shipping order 70. Upstream processes include multiple customers 10 submitting orders 20 to the product distributor, where each order 20 specifies one or more items from inventory 30 to be shipped to the customer that submitted the order. To fulfill the customer orders 20, the fulfillment network submits a downstream request to a payment gateway so that payment information provided by the customer is verified and charged. If successfully charged, the fulfillment network proceeds to further downstream processes. For example, one or more items specified in each order may be retrieved, or picked, from inventory 30 in a materials handling facility of the fulfillment network, as indicated at 40. Picked items may be delivered or conveyed, if necessary, to one or more stations in the materials handling facility for sorting 50 into their respective orders, packing 60, and finally shipping 70 to the customers 10.

A fulfillment network may also include a receiving 80 operation or area for receiving shipments of stock from one or more sources (e.g., vendors) and for placing the received stock into stock storage. Receiving 80 may also receive and process returned purchased or rented items or orders from customers. At least some of these items are typically returned to inventory 30.

The fulfillment network may not always respond as desired to every possible sequence of events from each upstream and downstream process. Accordingly, it may be desired to provide a simulation service that simulates the upstream and downstream processes in order to test the fulfillment network.

### Proxy Simulation Service

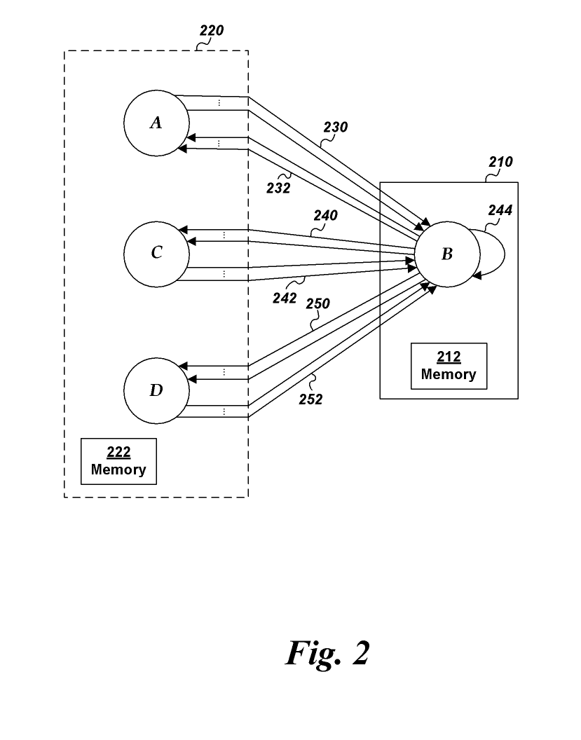

FIG. 2 is a block diagram of illustrative data flows and operations of a proxy simulation service 220, according to an embodiment, in communication with a system 210 that depends on upstream and downstream processes. For example, the system 210 may comprise an order fulfillment network, as described above, to be tested. System 210 may send information to, and receive information from, any number and combination of upstream and downstream process. However, to simply explanation, reference will be made to a particular sequence of upstream and downstream processes—namely, a sequence of steps to verify a customer's payment information once a customer has placed an order. It should be understood that the proxy simulation service disclosed herein may be configured to simulate any upstream and/or downstream processes to which the system under test may communicate. Other examples of upstream processes include when a customer changes or cancels an order. Other examples of downstream processes include the system 210 sending an order confirmation email to the customer.

The proxy simulation service 220 may be designed to simulate any number of upstream and downstream processes. For example, as shown in FIG. 2, node A may represent an upstream process by which a customer places an order. In particular, node A of the proxy simulation service 220 may send (e.g., push) at least one event 230 to the system 210 that indicates a customer has placed an order. In some embodiments, the proxy simulation service 220 may include simulated data with the pushed event 230. For example, the proxy simulation service 220 may include a customer's credit card information with the pushed event 230.

The system 210 may receive the pushed event (e.g., the customer order), at node B. The system 210 may be configured to attempt to verify the customer's payment information and process a charge. Accordingly, the system 210 initiates a request 240 based on the pushed event 230. In particular, the system 210 sends a request 240 to a payment gateway, based on the pushed customer order, to verify the customer's payment information and process a charge. In sending the request 240, the system 210 behaves in the same manner as it would if it were contacting an actual, rather than simulated, payment gateway. Instead of being received by a payment gateway, however, the request 240 is received by the proxy simulation service 220.

When the proxy simulation service 220 receives the request 240, the request 240 is delivered to node C for processing. Node C of the proxy simulation service 220 may represent a payment gateway. In some embodiments, the proxy simulation service 220 receives context information that indicates a node of an upstream or downstream process and interprets the received system request based on the context information. For example, the proxy simulation service 220 may receive context information, possibly provided by the system 210, that indicates that the request 240 is to be processed by node C, the payment gateway. Alternatively, the proxy simulation service 220 may be configured to deliver a request to a node for processing based on the request itself. For example, if a request 240 is a charge verification request, the proxy simulation service 220 may determine that the request 240 should be sent to node C, the payment gateway, for processing.

When node C of the proxy simulation service 220 receives the request 240, it decides how to process the request. For example, after receiving a charge verification request, the node C payment gateway may provide any of several responses. For example, the node C payment gateway may send a simulated response 242 to the system 210 that indicates successfully verifying the customer's payment information and processing a charge. Alternatively, the node C payment gateway may send a simulated response 242 to the system 210 that indicates not being able to process the customer's payment information and declining a charge. In both of these cases, the node C payment gateway provides a response 242 to the system 210 indicating either a successful charge or a failure. In addition, a real-world payment gateway may not provide any response. Accordingly, to accurately simulate a payment gateway, the node C payment gateway should be able to not provide any response 242 based on the received request 240.

As well as providing a response 242 indicating a successful charge or failure, the proxy simulation service 220 can be configured to provide data associated with the simulated response 242. For example, if the response 242 indicates that the charge verification request 240 was not successfully completed, the response 242 can include additional simulated data, such as indicating that an expiration date of a customer's credit card was not provided.

After sending the charge verification request 240, the system 210 should be designed to adequately respond to each possible response 242 from the payment gateway. For example, if the response 242 indicates that the charge was completed successfully, the system 210 may send another request 250 to verify that the item ordered by the customer is in stock. In addition, the system 210 may send an email to the customer indicating that the charge was completed successfully. When the proxy simulation service 220 receives the request 250, the request 250 may be delivered to node D for processing. Node D of the proxy simulation service 220 may represent a stock verification process. If simulating that an item is in stock, the node D stock verification process may provide a response 252 indicating that the item is in stock. Similarly, if simulating that an item is not in stock, the node D stock verification process may provide a response 252 indicating that the item is not in stock. In addition, as with the payment gateway, it may be the case that the stock verification process does not provide any response. Accordingly, to simulate the stock verification process, the node D stock verification process should be able to not provide any response 252 based on the received request 250.

The system 210 also should be designed to adequately respond to the other possible responses from the payment gateway. For example, if the response 242 indicates that the charge request was not completed successfully, the system 210 may send a request 232 to the customer asking for alternate payment information. When the proxy simulation service 220 receives the request 232, the request 232 may be delivered to node A for processing. In this sequence of events, node A of the proxy simulation service 220 is functioning as a downstream process configured to return a result. In response, the node A customer of the proxy simulation service 220 may provide alternate payment information through another event 230 subsequent to the initial pushed event 230.

The system 210 also should be designed to adequately respond to a time out from the payment gateway. For example, if no response 242 is received from the payment gateway after a certain period of time (e.g., 30 seconds), the system 210 may determine that the payment gateway has timed out. In particular, the system 210 at node B may loop back to itself repeatedly at step 244 until it either receives a response 242 or determines that the payment gateway has timed out. If it determines that the payment gateway has timed out, the system 210 may send a second request 240 to the payment gateway to verify the customer's payment information and process a charge.

As with the first charge verification request 240, the proxy simulation service 220 may deliver the second request 240 to the node C payment gateway for processing. As before, in response to the second request 240, the node C payment gateway may provide a simulated response 242 that indicates a successful charge, may provide a simulated response 242 that indicates a declined response, or may provide no response at all. In addition, when testing the system 210 with the proxy simulation service 220, it may be desirable to provide a different response 242 to the second charge verification request 240 than the response 242 provided (or not) to the first charge verification request 240. For example, a particular test case for the proxy simulation service 220 may provide no response 242 in response to the first charge verification request 240 to test whether the system 210 recognizes a payment gateway time out, and the proxy simulation service 220 may provide a successful charge response 242 in response to the second charge verification request 240.

In order to provide the intended sequence of simulated responses 242 to the charge verification requests 240, the proxy simulation service 220 should appreciate that a different response should be provided to the second charge verification request 240 than the first charge verification request 240. One way the proxy simulation service 220 could know to provide the intended sequence of simulated responses 242 would be to store a state in a memory 222 of the computing device implementing the proxy simulation service. For example, after receiving the first charge verification request 240, the proxy simulation service 220 could increment a counter to indicate that a first request was received, and proceed to provide no response. After receiving the second charge verification request 240, the proxy simulation service 220 could check the counter and determine that the charge request 240 being received is the second such request, and proceed to provide a response 242 indicating a successful charge. However, storing state information in the memory 222 of the computing device implementing the proxy simulation service 220 can be problematic. For example, as the number of pushed sequences of events increases, the memory 222 can quickly become overwhelmed as the number of complex sequences of events to keep track of grows. Storing state information in the memory 222 may not allow the proxy simulation service 220 to scale to test a system 210 that is intended to function with a high volume of event sequences.

According to some embodiments, the proxy simulation service 220 may receive state information based on a sequence of events associated with the system request. For example, the system 210 may comprise memory 212, and the system 210 may be configured to keep track of state information in memory 212. When the system 210 sends a request, such as a charge verification request 240, the system 210 may include state information based on the sequence of events associated with the charge verification request 240. In particular, the included state information may indicate the number of times a particular request has been sent. For example, the included state information may indicate that the sent charge verification request 240 is the second such request.

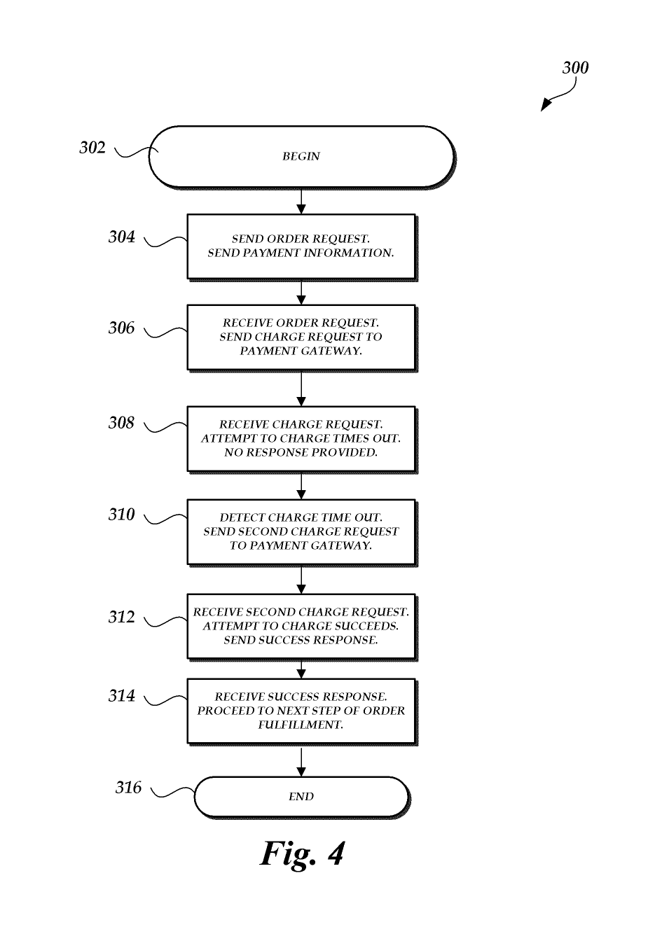

The proxy simulation service 220 may receive the provided state information. Based on the received request and the provided state information, the proxy simulation service 220 can determine which simulated response to provide to the system 210. For example, if the request is a charge verification request 240, and if the provided state information indicates that it is a second time that a charge verification request 240 has been received, the proxy simulation service 220 may determine that it should provide a simulated response 242 indicating a successful payment charge, as provided by the example test case. Determining which response should be provided may be based on test case instructions stored in memory 222. For example, a table may indicate which simulated responses should be provided in response to any combination of system requests and received state information, as further described with respect to FIG. 4. Simulating a response may include retrieving response from the memory 222.

In other embodiments, the system 210 may not include state information when sending system requests. For example, the proxy simulation service 220 may receive a charge verification request 240 from the system 210, but the proxy simulation service may not also receive at the same time, state information indicating the number of times that the system has sent a charge verification request. In such cases, the proxy simulation service 220 may send a request to receive the state information associated with the request. For example, the proxy simulation service 220 may send a request to the system 210 to provide the state information associated with the charge verification request 240. A hook routine may be provided on the system 210 for processing such a request and returning associated state information. In addition, in alternative embodiments, the hook routine for returning associated state information may be provided by a third-party system. For example, the proxy simulation service 220 may send a request to a third-party system to receive state information associated with a particular request. The third-party system may respond to the proxy simulation service 220 with the requested state information.

In some embodiments, the simulated response can include a command configured to control a next state of the system 210. For example, a response 242 indicating that a charge verification request 240 was completed successfully may be structured as a command configured to control a next state of the system 210. The next state of the system 210 may be to send a request 250 verifying an item that the customer ordered is in stock.

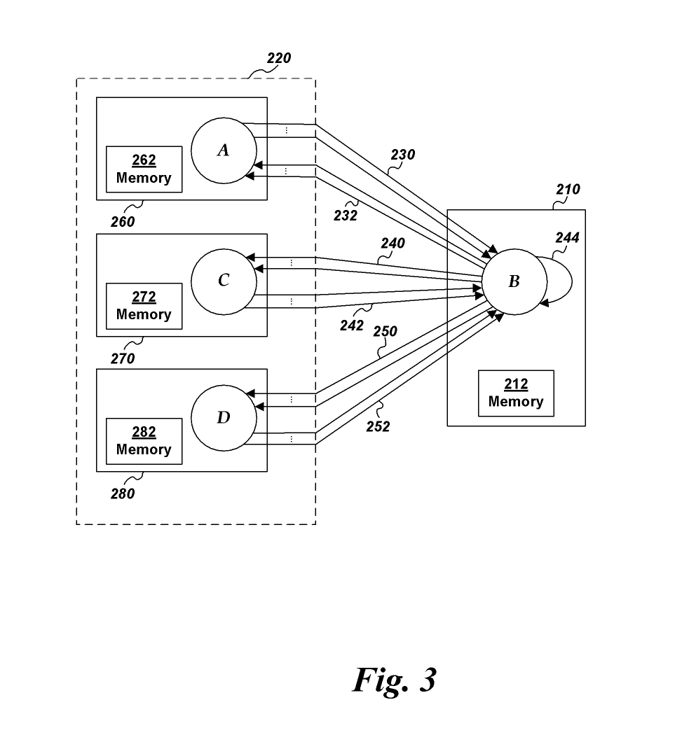

FIG. 3 is a block diagram of illustrative data flows and operations of another embodiment of a proxy simulation service 220 in communication with a system 210 that depends on upstream and downstream processes. The system 210 and proxy simulation service 220 may function in a similar manner as the system 210 and proxy simulation service 220 described above with respect to FIG. 2. However, in some embodiments, nodes A, B, and C of the proxy simulation service 220 may be implemented using a plurality of computing devices. For example, a first computing device 260 with a corresponding memory 262 may be configured to function as node A of the proxy simulation service 220. A second computing device 270 with a corresponding memory 272 may be configured to function as node C of the proxy simulation service 220. In addition, a third computing device 280 with a corresponding memory 282 may be configured to function as node D of the proxy simulation service 220.

In addition, testing the robustness of the system 210 by testing the number of events per unit time that the system 210 can process without error can be scaled by using a plurality of proxy simulation service devices simultaneously. Because each proxy simulation service device does not try to keep track of state in its memory, the proxy simulation service as a whole can be scaled without encountering problems associated with memory performance.

### Example Process for Simulating a Charge Request

With reference now to FIG. 4, an example process 300 of a particular test case for simulating a charge request according to an embodiment will be described. The process 300 begins at block 302. The process 300 may be embodied in hardware or a set of executable program instructions implemented by hardware. The process 300 may be performed, for example, by proxy simulation service 220 of FIG. 2. Although the process 300 of FIG. 4 may be described with respect to the components of FIG. 2, the process 300 is not limited to implementation by, or in conjunction with, any specific component shown in FIG. 2. In some embodiments, the process 300, or some variant thereof, may be implemented by alternative components, by the components of FIG. 2 in a different configuration, etc.

At block 304, a proxy simulation service 220 may push an event 230, such as an order request, to the system 210. In addition, the proxy simulation service 220 may include a customer's payment information with the order request 230. At block 306, the system 210 may receive the order request 230. Then, the system 210 may initiate a charge verification request 240 to a payment gateway.

At block 308, the simulation service 220 may receive the charge verification request 240. In addition, the simulation service may receive state information based on the charge verification request 240 indicating the first occurrence of a charge verification request 240. According to the particular test case, which may be determined by instructions stored in memory 222, and based on the request being a charge verification request and the state information indicating the first such request, the proxy simulation service 220 may determine not to send any response.

At block 310, the system 210 may determine after a certain period of time has elapsed that a charge time out has occurred. Accordingly, the system 210 may send a second charge verification request 240 to the proxy simulation service 220. Next, at block 312, the simulation service 220 may receive the second charge verification request 240. In addition, the simulation service again may receive state information based on the charge verification request 240 indicating the second occurrence of a charge verification request 240. According to the particular test case, and based on the request being a charge verification request and the state information indicating the second such request, the proxy simulation service 220 may determine to send a response 242 to the system 210 indicating a successful payment charge. At block 314, the system 210 may receive the response 242 indicating a successful payment charge. The system 210 may proceed to the next step of order fulfillment by sending a request 250 to the stock verification process. At block 316, this particular test case ends. However, it should be understood that a test case can be configured to continue with any number of upstream or downstream processes.

### Example Table of Simulated Responses

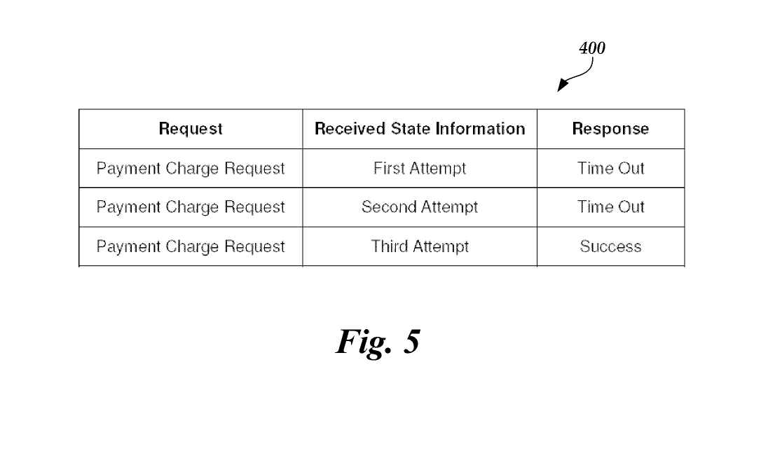

FIG. 5 illustrates a table 400 of example responses of a proxy simulation service according to an embodiment, based on received request and state information. For example, the information in the table 400 may be stored in memory 222 of the proxy simulation service 220. Alternatively, the table 400 may not be stored in memory 222 of the computing device implementing proxy simulation service 220, but may instead be received by the computing device implementing the proxy simulation service 220. For example, the information of table 400 may be received by the proxy simulation service 220 with instructions specifying a test case. According to the test case defined by table 400, for payment charge requests, the table 400 specifies that if the received state information indicates the first or the second occurrence of the payment charge request, the proxy simulation service 220 should cause a charge time out and not provide a response. The table 400 also specifies that if the received state information indicates the third occurrence of the payment charge request, the proxy simulation service 220 should provide a simulated response indicating a successful charge.

Although table 400 only specifies simulated responses for one type of request and the first three attempts, it should be appreciated that the table 400 can specify any type of request and receiving state information specifying any number of attempts with respect to the corresponding request.

### Example Process of a Stateless Simulation Service

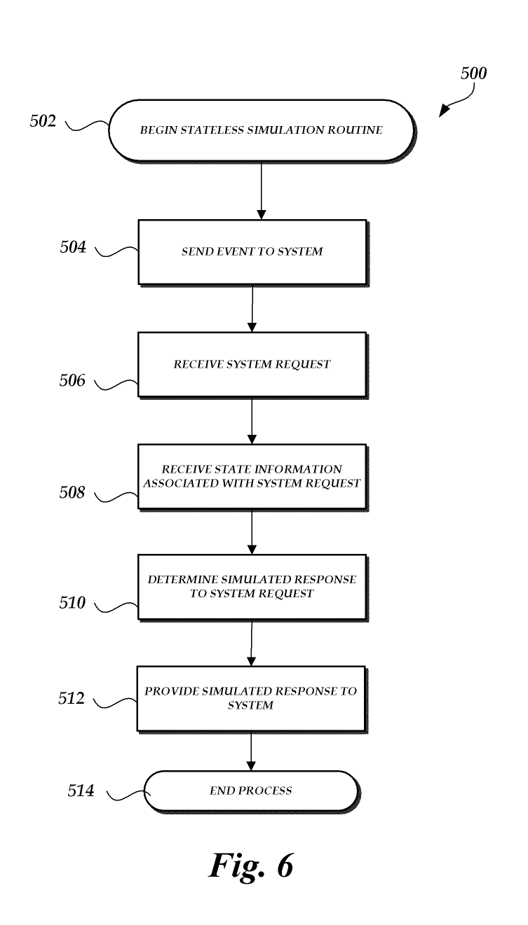

With reference now to FIG. 6, an example process 500 for performing a stateless simulation routine according to an embodiment will be described. The process 500 begins at block 502. The process 500 may be embodied in hardware or a set of executable program instructions implemented in hardware. The process 500 may be performed, for example, by the proxy simulation service 220 of FIG. 2. Although the process 500 of FIG. 6 will be described with respect to the components of FIG. 2, the process 500 is not limited to implementation by, or in conjunction with, any specific component shown in FIG. 2. In some embodiments, the process 500, or some variant thereof, may be implemented by alternative components, by the components of FIG. 2 in a different configuration, etc.

At block 504, an event (e.g., one of a sequence of events) may be sent, or pushed, to a system. For example, a proxy simulation service 220 sends an event 230 indicating a customer order. At block 506, a system request may be received based on the sent event. For example, the proxy simulation service 220 receives a charge verification request 240 based on the pushed event 230 indicating a customer order. Next, at block 508, state information associated with the system request may be received. For example, the proxy simulation service 220 may receive state information that indicates a number of times the system request has been sent. In particular, with respect to the charge verification example, the proxy simulation service 220 may receive state information indicating a first such charge verification request 240.

At block 510, a simulated response to the received system request may be determined based on at least the received system request and the received state information. For example, the proxy simulation service may determine a simulated response indicating a successful or unsuccessful charge, or may not provide any response, based on the received system request being a charge verification request 240 and based on the received state information indicating the number of times a charge verification request 240 has been sent. At block 512, the simulated response may be provided to the system. At block 514, the process ends.

### Illustrative System

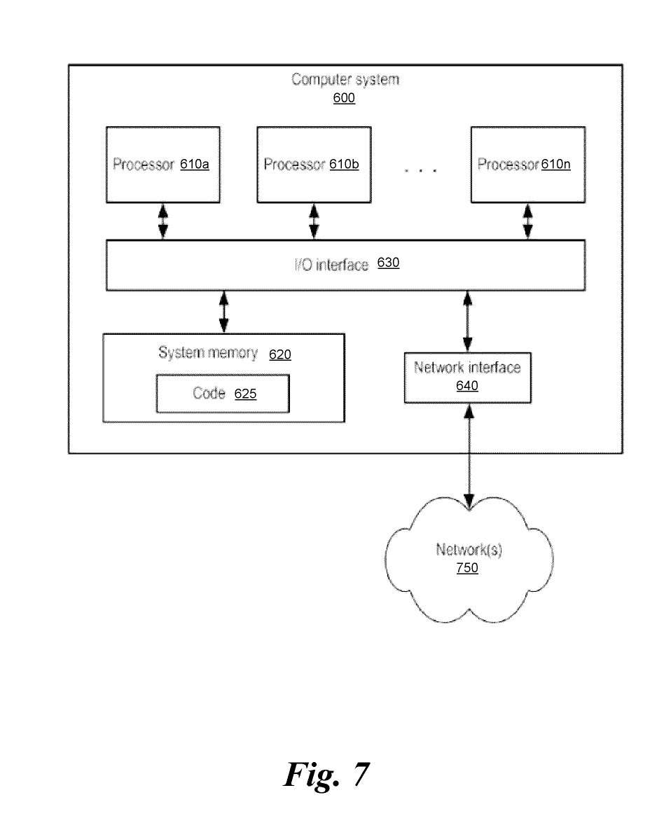

In one embodiment, a system that implements one or more components of a stateless simulation service as described herein may include a computer system that includes or is configured to access one or more computer-accessible media, such as computer system 600 illustrated in FIG. 7. In the illustrated embodiment, computer system 600 includes one or more hardware processors 610 coupled to a system memory 620 via an input/output (I/O) interface 630. Computer system 600 further includes a network interface 640 coupled to I/O interface 630.

In various embodiments, computer system 600 may be a uniprocessor system including one processor 610, or a multiprocessor system including several processors 610a, 610b, . . . , 610n (e.g., two, four, eight, or another suitable number). Processors 610 may be any suitable processors capable of executing instructions. For example, in various embodiments, processors 610 may be general-purpose or embedded processors implementing any of a variety of instruction set architectures (ISAs), such as the x86, PowerPC, SPARC, or MIPS ISAs, or any other suitable ISA. In multiprocessor systems, each of processors 610 may commonly, but not necessarily, implement the same ISA.

System memory 620 may be configured to store instructions and data accessible by processor(s) 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those methods and techniques described above for a stateless simulation service, are shown stored within system memory 620 as code 625.

In one embodiment, I/O interface 630 may be configured to coordinate I/O traffic between processor 610, system memory 620, and any peripheral devices in the device, including network interface 640 or other peripheral interfaces. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network 650, such as other computer systems or communications devices. The communications channels may include, but are not limited to conventional and mobile telephone and text messaging communications channels. Network interface 640 may commonly support one or more wireless networking protocols (e.g., Wi-Fi/IEEE 802.11, or another wireless networking standard). However, in various embodiments, network interface 640 may support communication via any suitable wired or wireless general data networks, such as other types of Ethernet network, for example. Additionally, network interface 640 may support communication via telecommunications/telephony networks such as analog voice networks or digital fiber communications networks, via storage area networks such as Fibre Channel SANs, or via any other suitable type of network and/or protocol.

In some embodiments, system memory 620 may be one embodiment of a non-transitory computer-readable storage medium configured to store program instructions and data as described above for FIGS. 2 through 6 for implementing a stateless simulation service. However, in other embodiments, program instructions and/or data may be received, sent or stored upon different types of computer-readable media. Generally speaking, a computer-accessible medium may include storage media or memory media such as magnetic or optical media, e.g., disk or DVD/CD coupled to computer system 600 via I/O interface 630. A computer-readable medium may also include any volatile or non-volatile media such as RAM (e.g. SDRAM, DDR SDRAM, RDRAM, SRAM, etc.), ROM, etc., that may be included in some embodiments of computer system 600 as system memory 620 or another type of memory.

### Terminology

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines and algorithm steps described in connection with the embodiments disclosed herein can be implemented as electronic hardware, computer software, or combinations of both. To clearly illustrate this interchangeability of hardware and software, various illustrative components, blocks, modules and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The elements of a method, process, routine, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y and Z,” unless specifically stated otherwise, is to be understood with the context as used in general to convey that an item, term, etc. may be either X, Y or Z, or a combination thereof. Thus, such conjunctive language is not generally intended to imply that certain embodiments require at least one of X, at least one of Y and at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described and pointed out novel features as applied to various embodiments, it can be understood that various omissions, substitutions and changes in the form and details of the devices or algorithms illustrated can be made without departing from the spirit of the disclosure. As can be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A system comprising:
a data store configured to at least store data regarding a plurality of events; and
a computing device in communication with the data store, the computing device configured to at least:
send data regarding an event of the plurality of events to a computing system, wherein the computing system is configured to receive data regarding events from a previous process upon which the computing system depends, and wherein the computing device sends the data regarding the event to the computing system as a proxy of the previous process;
receive from the computing system a request based at least in part on the sent data regarding the event, wherein the computing system is configured to send system requests to a subsequent process upon which the computing system depends, and wherein the computing device sends the system request to the computing system as a proxy for the subsequent process;
receive state information associated with the received system request from a source external to the computing device;
determine a simulated response to the received system request based at least in part on at least the received system request and the received state information;
provide the simulated response to the computing system; and
validate a state of the computing system after receiving the simulated response.

2. The system of claim 1, wherein the received state information is indicative of a number of times that the computing system has sent a request based at least in part on the sent data regarding the event.

3. The system of claim 1, wherein the source external to the computing device comprises the computing system.

4. The system of claim 1, wherein the computing device is further configured to at least send, after receiving the system request, a request for the state information associated with the system request.

5. The system of claim 1, wherein the simulated response comprises a command configured to control a next state of the computing system.

6. The system of claim 1, wherein determining the simulated response comprises retrieving the simulated response from the data store.

7. The system of claim 1, wherein the computing device is further configured to at least:
provide data associated with the sent event data; and
provide data associated with the simulated response;
wherein the provided data is included with the sent event data and the simulated response.

8. The system of claim 1, wherein the computing device is further configured to at least:
receive context information indicative of a node of an upstream or downstream process; and
interpret the received system request based at least in part on the context information.

9. The system of claim 1, wherein the computing device is further configured to send event data for at least five hundred events per minute.

10. The system of claim 1, wherein the simulated response comprises a plurality of commands.

11. A computer-implemented method comprising:
receiving, from a computing system at a computing device, a system request based at least in part on data regarding an event sent to the computing system, wherein the computing system is configured to receive data regarding events from a first process, and the computing system is configured to send system requests to a second process;
receiving, at the computing device, state information associated with the system request from a source external to a computing device;
determining, at the computing device, a simulated response to the system request based at least in part on at least the system request and the state information; and
providing the simulated response to the computing system.

12. The computer-implemented method of claim 11, wherein the received state information is indicative of a number of times that the computing system has sent the system request.

13. The computer-implemented method of claim 11, wherein the state information is received from the computing system.

14. The computer-implemented method of claim 11, further comprising sending, after receiving the system request, a request for the state information associated with the system request.

15. The computer-implemented method of claim 11, wherein the simulated response comprises a command configured to control a next state of the computing system.

16. The computer-implemented method of claim 11, further comprising:
providing data associated with the sent event data; and
providing data associated with the simulated response,
wherein the provided data is included with the sent event data and the simulated response.

17. The computer-implemented method of claim 11, further comprising:
receiving context information associated with at least one of the first process or the second process; and
interpreting the received system request based at least on the context information.

18. The computer-implemented method of claim 11, further comprising sending to the computing system event data for at least five hundred events per minute.

19. The computer-implemented method of claim 11, wherein the simulated response comprises a plurality of commands.

20. Non-transitory computer-readable storage storing computer executable instructions thereon, wherein the instructions, when executed by a computing device, configure the computing device to perform operations comprising:
receiving from a computing system a request based at least in part on data regarding an event sent to the computing system, wherein the computing system is configured to receive data regarding events from a first process, and the computing system is configured to send system requests to a second process;
receiving state information associated with the system request from an external source;
determining a simulated response to the system request based at least in part on at least the system request and the state information; and
providing the simulated response to the computing system.

21. The non-transitory computer-readable storage of claim 20, wherein the received state information is indicative of a number of times that the computing system has sent the system request.

22. The non-transitory computer-readable storage of claim 20, wherein the state information is received from the computing system.

23. The non-transitory computer-readable storage of claim 20, wherein the simulated response comprises a command configured to control a next state of the system.
